(19) United States
(12) Patent Application Publication
(10) Pub. No.: US 2014/0308932 A1
(43) Pub. Date: Oct. 16, 2014

(54) METHOD OF AND APPARATUS FOR TRANSMITTING/RECEIVING DIGITAL SIGNAGE CONTENTS

(71) Applicant: Electronics & Telecommunications Research Institute, Daejeon (KR)

(72) Inventors: Jung Soo LEE, Daejeon (KR); Jeong Woo Lee, Daejeon (KR); Hyo Taeg Jung, Daejeon (KR); Bum Ho Kim, Daejeon (KR); Yeon Jeong Jeong, Daejeon (KR); Sung Won Moon, Suwon-si (KR); Ki Song Yoon, Daejeon (KR)

(73) Assignee: Electronics & Telecommunications Research Institute, Daejeon (KR)

(21) Appl. No.: 14/133,860

(22) Filed: Dec. 19, 2013

(30) Foreign Application Priority Data
Apr. 12, 2013 (KR) 10-2013-0040435

(51) Int. Cl. H04W 4/20; H04W 4/18

(52) U.S. Cl. CPC H04W 4/20; H04W 4/18
USPC 455/414.1

(57) ABSTRACT

A method of transmitting and receiving digital signage contents, which is capable of easily transmitting and receiving digital signage contents using a smartphone's application, is disclosed. According to an aspect, the method of transmitting and receiving digital signage contents includes: executing an application; transmitting a message for requesting digital signage contents displayed on a digital signage display device to a digital signage manager through the application; receiving the digital signage contents from the digital signage manager; and outputting the received digital signage contents. Accordingly, a user may easily and quickly receive digital signage contents using a smartphone's application, and also, a plurality of users may simultaneously use the same digital signage contents through their terminals. In addition, it is possible to objectively determine the degrees of users' concern and preference about advertisements and digital signage contents.

### CLAIM FOR PRIORITY

This application claims priority to Korean Patent Application No. 10-2013-0040435 filed on Apr. 12, 2013 in the Korean Intellectual Property Office (KIPO), the entire contents of which are hereby incorporated by reference.

### BACKGROUND

1. Technical Field

Example embodiments of the present invention relate in general to transmission and reception of digital signage contents, and more specifically, to a method and apparatus for easily transmitting and receiving digital signage contents.

2. Related Art

Digital signage is a digital display that can be remotely controlled through a network. The digital signage is installed in a public place, a commercial place, etc. to provide various kinds of information, such as entertainment, advertisements, etc.

Lately, with development of digital signage industry, various digital signage displays are installed in off-line shopping malls, street signboards, elevators, etc. to provide various advertisement images (for example, still images, moving images, etc.), and the market of digital signage is fast-growing.

Particularly, digital signage that supports interactions for bidirectional communication through combination with various IT and contents-related technology has been introduced.

However, as the amount of digital signage contents significantly increases, a problem related to contents transmission is on the rise.

Also, although the interaction function of digital signage display is credited for bidirectional communication, there are still many limitations in many users simultaneously using digital signage at different places.

Also, since it is difficult to objectively determine the degrees of users' concern and preference about advertisements and digital signage contents, demands regarding how to schedule and manage contents based on users' concern and preference are increasing.

### SUMMARY

Accordingly, example embodiments of the present invention are provided to substantially obviate one or more problems due to limitations and disadvantages of the related art.

Example embodiments of the present invention provide a method of transmitting and receiving digital signage contents, which is capable of easily transmitting digital signage contents using a smartphone's application.

Example embodiments of the present invention also provide an apparatus for transmitting and receiving digital signage contents, which is capable of easily transmitting digital signage contents using a smartphone's application.

In some example embodiments, a method of transmitting and receiving digital signage contents, which is performed by a user terminal, includes: executing an application; transmitting a message for requesting digital signage contents displayed on a digital signage display device to a digital signage manager through the application; receiving the digital signage contents from the digital signage manager; and outputting the received digital signage contents.

The method may further include performing an interaction on the output digital signage contents based on an input from a user, and transmitting the results of the interaction to the digital signage manager.

The method may further include: receiving a message for requesting the output digital signage contents from another terminal; acquiring the digital signage contents corresponding to the received message; and transmitting the acquired digital signage contents to the other terminal.

The method may further include: creating basic information for compensation including at least one piece of information among information regarding a time period for which the application has been executed, information regarding a time period taken to transmit the digital signage contents to the other terminal, information regarding the amount of transmitted data, and information regarding a time at which the digital signage contents are output; and transmitting the generated basic information for compensation to the digital signage manager.

The user terminal may exchange contents with the other terminal through the application using the same communication method between the terminals. The communication method may be at least one of Bluetooth, Zigbee, Wi-Fi, Device to Device (D2D), Near Field Communication (NFC), 3^{rd} Generation (3G), Long Term Evolution (LTE), and Wireless Broadband (WiBro).

Particularly, according to a data communication method, such as Wi-Fi, 3G, LTE, etc., by split-transmitting signage contents between applications installed in the terminals through P2P communication such as BitTorrent, the terminals may exchange the signage contents at a high speed. Also, since contents are transmitted and received through the applications installed in the terminals, privacy is ensured, and the user may easily subscribe to a service or unsubscribe from the service through management of applications.

In other example embodiments, a method of transmitting and receiving digital signage contents includes: receiving a message for requesting digital signage contents displayed on a digital signage display device from a terminal; acquiring the digital signage contents corresponding to the message; converting the acquired digital signage contents; and transmitting the converted digital signage contents to the terminal.

The converting of the acquired digital signage contents may include converting the acquired digital signage contents such that the digital signage contents satisfy at least one of a file format and resolution that are supported by the terminal.

The method may further include receiving interaction information from the terminal, and transmitting a response corresponding to the received interaction information to the terminal.

The method may further include: receiving, from the terminal, basic information for compensation including at least one piece of information among information regarding a time period for which an application has been executed, information regarding a time period taken to transmit the digital signage contents to another terminal, information regarding the amount of transmitted data, and information regarding a time at which the digital signage contents have been output; creating compensation information based on the received basic information for compensation; and transmitting the created compensation information to the terminal.

The compensation information may include arbitrary compensation contents in proportion to the operating time of the application and the amount of transmitted data, including coupon information, discount information for mobile phone payment, gift certificate information, point savings information, etc.

In still other example embodiments, a method of transmitting and receiving digital signage contents includes: executing an application; transmitting a message for requesting digital signage contents to another terminal through execution of the application; receiving the digital signage contents from a specific terminal; and outputting the received digital signage contents.

Communication with the other terminal may be performed through at least one of Bluetooth, Zigbee, Wi-Fi, Device to Device (D2D), Near Field Communication (NFC), 3^{rd} Generation (3G), Long Term Evolution (LTE), and Wireless Broadband (WiBro).

Particularly, according to a data communication method, such as Wi-Fi, 3G, LTE, etc., by split-transmitting signage contents between applications installed in the terminals through P2P communication such as BitTorrent, the terminals may exchange the signage contents at a high speed.

The method may further include: storing the received digital signage contents; receiving a message for requesting the received digital signage contents from another terminal than the specific terminal; and transmitting the received digital signage contents to the other terminal than the specific terminal.

In still other example embodiments, a terminal performing a method of transmitting and receiving digital signage contents includes: a storage unit; a communication unit configured to perform communication; an output unit configured to output digital signage contents; and a processor configured to transmit a message for requesting the digital signage contents displayed on a digital signage display device to a digital signage manager by execution of an application through the communication unit, to receive the digital signage contents from the digital signage manager, and to output the received digital signage contents through the output unit.

The processor may perform an interaction on the output digital signage contents based on an input from a user through the output unit, and transmit the results of the interaction to the digital signage manager through the communication unit.

If the processor receives a message for requesting the digital signage contents from another terminal through the communication unit, the processor may acquire the digital signage contents corresponding to the message from the storage unit, and transmit the acquired digital signage contents to the other terminal.

The terminal may further include a compensation manager configured to create basic information for compensation including at least one piece of information among information regarding a time period for which the application has been executed, information regarding a time period taken to transmit the digital signage contents to the other terminal, information regarding the amount of transmitted data, and information regarding a time at which the digital signage contents have been output, and to provide the basic information for compensation to the processor.

The communication unit may perform communication with the other terminal through at least one of Bluetooth, Zigbee, Wi-Fi, Device to Device (D2D), Near Field Communication (NFC), 3^{rd} Generation (3G), Long Term Evolution (LTE), and Wireless Broadband (WiBro) under the control of the processor. Particularly, according to a data communication method, such as Wi-Fi, 3G, LTE, etc., by split-transmitting signage contents between applications installed in the terminals through P2P communication such as BitTorrent, the terminals may exchange the signage contents at a high speed.

Therefore, according to the method of and apparatus for transmitting and receiving digital signage contents, a user terminal receives digital signage contents displayed on a digital signage display device from a digital signage manager and outputs the digital signage contents by executing an application based on an input from a user, and transmits, if receiving a transmission command for transmitting all or a part of contents from the digital signage manager, the all or part of contents to another terminal according to the received transmission command.

Accordingly, a user may easily and quickly receive digital signage contents using a smartphone's application, and also, a plurality of users may simultaneously use the same digital signage contents through their terminals. In addition, it is possible to objectively determine the degrees of users' concern and preference about advertisements and digital signage contents.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view illustrating an operating environment in which a method of transmitting and receiving digital signage contents, according to an embodiment of the present invention, is performed;

FIG. 2 is a flowchart illustrating the method of transmitting and receiving digital signage contents, according to the embodiment of the present invention;

FIG. 3 is a flowchart illustrating a process of transmitting and receiving digital signage contents, which is performed by a user terminal, according to an embodiment of the present invention;

FIG. 4 is a flowchart illustrating a process of transmitting and receiving digital signage contents, which is performed by a user terminal, according to another embodiment of the present invention;

FIG. 5 is a flowchart illustrating a process of transmitting and receiving digital signage contents, which is performed by a digital signage manager, according to an embodiment of the present invention;

FIG. 6 is a flowchart illustrating a process of transmitting and receiving digital signage contents when a contents request message is not a first received message, which is performed by a digital signage manager, according to another embodiment of the present invention;

FIG. 7 is a flowchart illustrating a process of transmitting and receiving digital signage contents, which is performed by another terminal, according to an embodiment of the present invention;

FIG. 8 is a block diagram illustrating a configuration of a user terminal which performs the method of transmitting and receiving digital signage contents, according to an embodiment of the present invention; and

FIG. 9 is a block diagram illustrating a configuration of a digital signage manager which performs the method of transmitting and receiving digital signage contents, according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention; however, example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

In this disclosure, a terminal and a digital signage manager may be desktop computers, laptop computers, tablet PCs, wireless phones, mobile phones, smartphones, e-book readers, portable multimedia players (PMPs), portable game devices, navigation systems, digital cameras, digital multimedia broadcasting (DMB) receivers, digital audio recorders, digital audio players, digital picture recorders, digital picture players, digital video recorders, digital video players, etc.

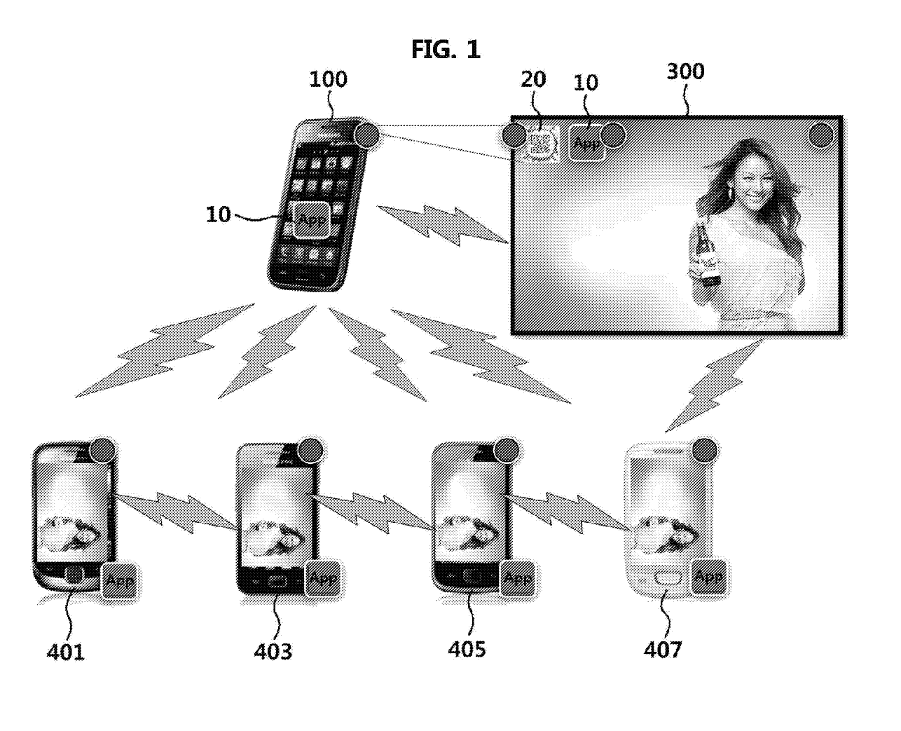

FIG. 1 is a conceptual view illustrating an operating environment in which a method of transmitting and receiving digital signage contents, according to an embodiment of the present invention, is performed.

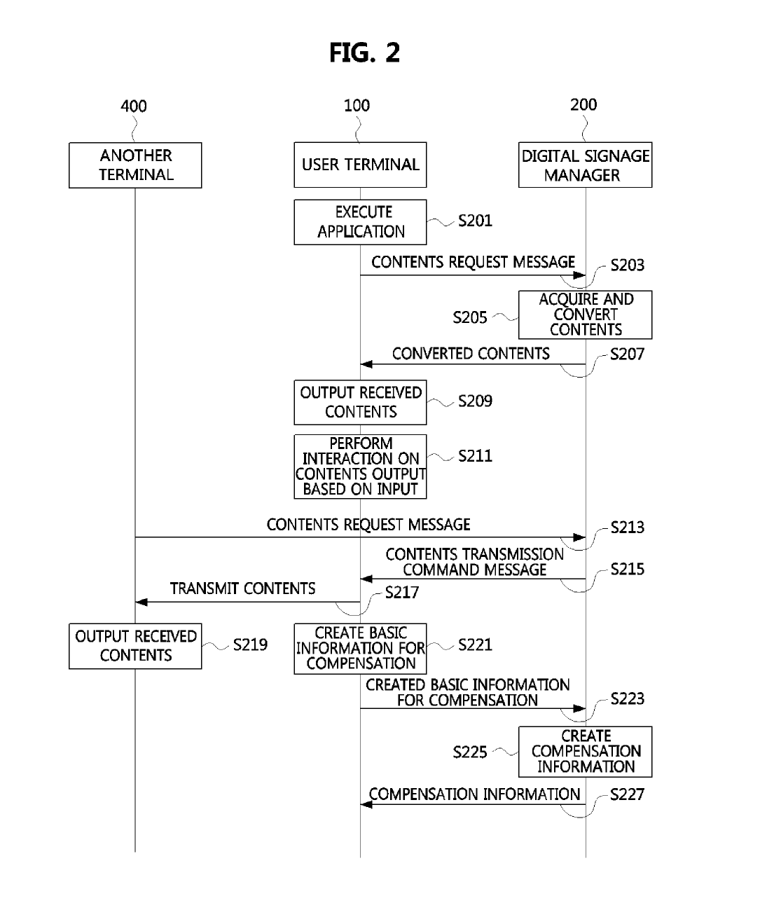

Referring to FIG. 1, the method of transmitting and receiving the digital signage contents is performed in an environment where a user terminal 100, a digital signage manager 200 (see FIG. 2), a digital signage display device 300, and other terminals 401, 403, 405, and 407 exist.

The digital signage display device 300 displays advertisement contents under the control of the digital signage manager 200.

The user terminal 100 downloads a digital signage application 10 for transmitting and receiving the digital signage contents according to an input from a user.

Here, the user terminal 100 can download the digital signage application 10 using Uniform Resource Locator (URL) information provided together with the advertisement contents displayed on the digital signage display device 300. The URL information may be provided as a QR code or the like for a user's convenience.

Also, the user terminal 100 may execute the downloaded digital signage application 10, and output the same advertisement contents as the advertisement contents being displayed on the digital signage display device 300.

If the advertisement contents are digital signage contents allowing interactions, the digital signage contents can interact with the user terminal 100 and the digital signage manager 200 or with the user terminal 100 itself according to an input from a user. Particularly, an interaction with the digital signage manager 200 may be performed in such a manner that when high computing power such as rendering is required, the user terminal 100 receives the results of rendering performed by the digital signage manager 200.

Also, the user terminal 100 may transmit the stored digital signage contents to the other terminals 401, 403, 405, and 407 that use the same digital signage application 10.

At this time, the contents transmission between the user terminal 100 and the other terminals 401, 403, 405, and 407 may be performed through Bluetooth, Zigbee, Wi-Fi, Device to Device (D2D), Near Field Communication (NFC), 3^{rd} Generation (3G), Long Term Evolution (LTE), Wireless Broadband (WiBro), etc.

FIG. 2 is a flowchart illustrating the method of transmitting and receiving digital signage contents, according to the embodiment of the present invention.

Referring to FIGS. 1 and 2, the user terminal 100 executes a digital signage application (DS APP) installed in advance, according to an input from a user (S201).

The user terminal 100 may connect to an URL address for downloading the digital signage application through a one-dimensional barcode, a two-dimensional barcode, or a QR code, etc. displayed on the digital signage display device 300.

Then, the user terminal 100 transmit a contents request message for requesting digital signage contents displayed on the digital signage display device 300 to the digital signage manager 200 through the digital signage application executed through operation S201 (S203).

If the contents request message transmitted through operation S203 is a first received message, the digital signage manager 200 acquires the corresponding digital signage contents, and converts the acquired digital signage contents into a file format that is supported by the user terminal 100 (S205).

However, if the contents request message is not a first received message, the digital signage manager 200 may request other terminals storing or receiving the requested contents to schedule and split-transmit the contents.

Then, the digital signage manager 200 transmits the converted digital signage contents through operation S205 to the user terminal 100 (S207).

The user terminal 100 outputs the received digital signage contents through operation S207 so that the user can check the digital signage contents (S209).

If the digital signage contents are contents allowing interactions, the user terminal 100 performs an interaction on the digital signage contents based on an input from the user (S211).

Thereafter, another terminal 400 executes a digital signage application installed in advance, according to an input from a user, and transmits a contents request message to the digital signage manager 200 (S213).

If the digital signage manager 200 receives the contents request message from the other terminal 400 through operation S213, the digital signage manager 200 determines that the contents request message is not a first received message, and transmits a contents transmission command message to other user terminals (including the user terminal 100) that are executing the digital signage application and have already downloaded the requested contents so that the other user terminals split-transmit the contents to the other terminal 400 (S215).

Accordingly, the user terminal 100 transmits a part of the contents to the other terminal 400 in response to the contents transmission command message received from the digital signage manager 200 through operation S215 (S217).

The other terminal 400 receives parts of the contents from the user terminal 100 and the digital signage display device 300, and outputs the received contents (S219).

After transmitting the part of the contents to the other terminal 400 through operation S217, the user terminal 100 creates basic information for compensation based on information regarding a time period for which the digital signage application has been executed, information regarding a time period taken to transmit the digital signage contents to the other terminal 400, information regarding the amount of transmitted data, etc. (S221).

Thereafter, the user terminal 100 transmits the basic information for compensation through operation S221 to the digital signage manager 200 (S223).

Then, the digital signage manager 200 creates compensation information based on the information regarding the time period for which the digital signage application has been executed, the information regarding the time period taken to transmit the digital signage contents to the other terminal 400, the information regarding the data amount of the transmitted contents, etc., included in the basic information for compensation received through operation S223 (S225).

Here, the compensation information may include coupon information, discount information for mobile phone payment, gift certificate information, point savings information, etc.

Then, the digital signage manager 200 transmits the compensation information created through operation S225 to the user terminal 100 (S227).

Therefore, according to the method of transmitting and receiving digital signage contents, a plurality of users can simultaneously use the same contents, and receive contents displayed on another terminal from terminals that store or receive the contents, resulting in an improvement of a contents transfer rate.

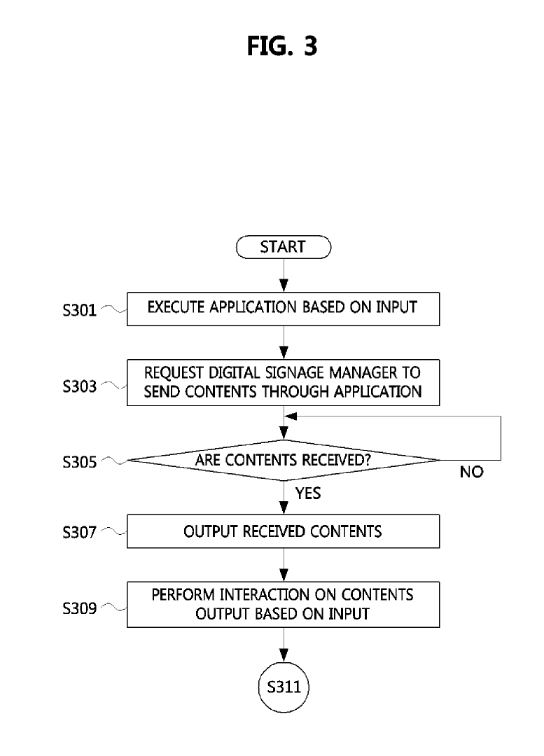

FIG. 3 is a flowchart illustrating a process of transmitting and receiving digital signage contents, which is performed by the user terminal 100, according to an embodiment of the present invention.

It is assumed that the digital signage display device 300 (see FIG. 1) displays digital signage contents.

Referring to FIGS. 1, 2, and 3, the user terminal 100 executes a digital signage application according to an input from a user (S301).

The user terminal 100 may download the digital signage application by connecting to a link for downloading the digital signage application through a one-dimensional barcode, a two-dimensional barcode, or a QR code, etc. displayed on the digital signage display device 300 according to an input from the user.

Then, the user terminal 100 executes the digital signage application through operation S301, and transmits a digital signage contents request message to the digital signage manager 200 through the executed digital signage application (S303).

Thereafter, the user terminal 100 determines whether digital signage contents are received from the digital signage manager 200 (S305).

If digital signage contents are received, the user terminal 100 stores and outputs the received digital signage contents (S307).

Then, the user terminal 100 performs an interaction on the output digital signage contents according to an input from the user (S309).

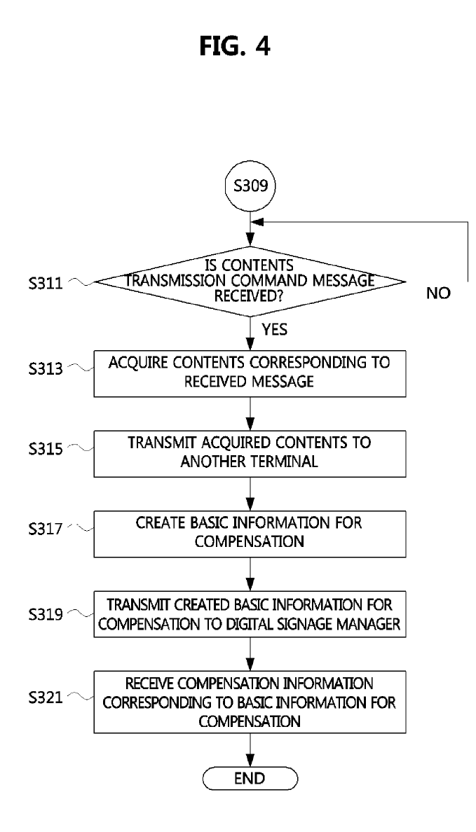

FIG. 4 is a flowchart illustrating a process of transmitting and receiving digital signage contents, which is performed by the user terminal 100, according to another embodiment of the present invention.

Referring to FIGS. 1, 2, and 4, the user terminal 100 determines whether a contents transmission command message is received after operation S309 of FIG. 3 (S311).

If a contents transmission command message is received from the digital signage manager 200 through operation S311, the user terminal 100 acquires contents corresponding to the received contents transmission command message (S313), and transmits the acquired contents to another terminal 400 (S315).

Thereafter, the user terminal 100 creates basic information for compensation based on information regarding a time period for which the digital signage application has been executed, information regarding a time period taken to transmit the digital signage contents to the other terminal 400, information regarding the amount of transmitted data, information regarding a time at which the digital signage contents have been output, etc. (S317).

Then, the user terminal 100 transmits the basic information for compensation created through operation S317 to the digital signage manager 200 (S319).

Thereafter, the user terminal 100 receives compensation information corresponding to the basic information for compensation from the digital signage manager 200 (S321).

Here, the compensation information may include coupon information, discount information for mobile phone payment, gift certificate information, point savings information, etc.

Therefore, according to the embodiment of the present invention, it is possible to provide effective advertisements through a plurality of terminals using a digital signage application, while enabling the terminals to download digital signage contents at a high speed.

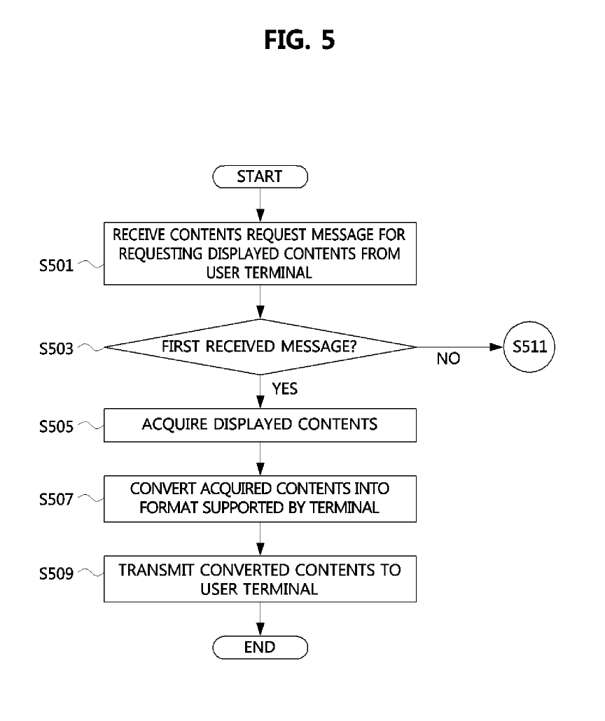

FIG. 5 is a flowchart illustrating a process of transmitting and receiving digital signage contents, which is performed by the digital signage manager 200, according to an embodiment of the present invention.

Referring to FIGS. 1, 2, and 5, the digital signage manager 200 receives a digital signage contents request message for requesting digital signage contents displayed on the digital signage display device 300, from the user terminal 100 (S501).

The digital signage contents request message may include information about a file format and resolution that are supported by the user terminal 100.

Then, the digital signage manager 200 determines whether the digital signage contents request message received through operation S501 is a first received contents request message (S503).

If the digital signage contents request message received through operation S503 is a first received contents request message, the digital signage manager 200 acquires digital signage contents displayed on the digital signage display device 300 (S505).

Then, the digital signage manager 200 converts the acquired digital signage contents through operation S505 into a file format and/or resolution that is supported by the user terminal 100 (S507), and transmits the converted digital signage contents to the user terminal 100 (S509).

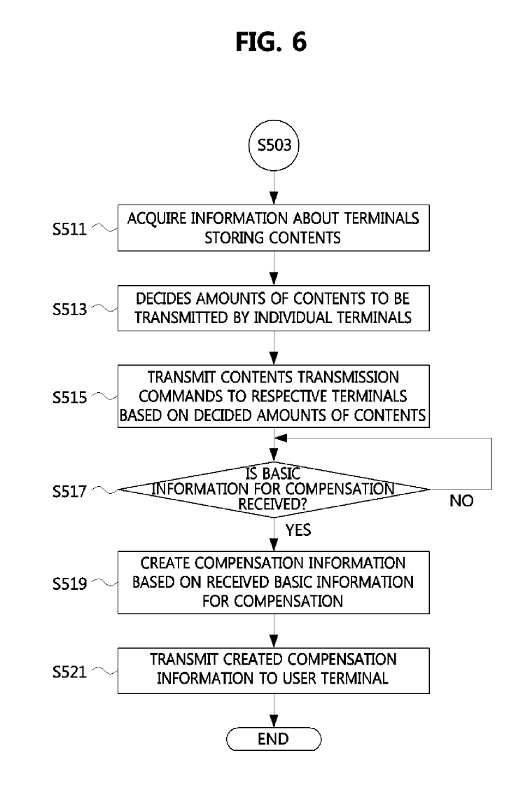

FIG. 6 is a flowchart illustrating a process of transmitting and receiving digital signage contents when a contents request message is not a first received message, which is performed by the digital signage manager 200, according to another embodiment of the present invention.

Referring to FIGS. 1, 2, and 6, if the digital signage contents request message received through operation S503 (see FIG. 5) is not a first received contents request message, the digital signage manager 200 acquires information about peripheral terminals that store the corresponding digital signage contents (S511).

The peripheral terminals that store the corresponding digital signage contents include terminals that store a part of the digital signage contents, that is, terminals that are currently downloading the digital signage contents, as well as terminals that store all of the digital signage contents.

Thereafter, the digital signage manager 200 decides the amounts of contents that are to be transmitted by the individual peripheral terminals if information about the peripheral terminals is acquired through operation S511 (S513).

Then, the digital signage manager 200 transmits contents transmission commands to the respective terminals based on the decided amounts of contents through operation S513 (S515).

Thereafter, the digital signage manager 200 determines whether basic information for compensation is received from the individual terminals (S517).

Here, the basic information for compensation may include information regarding a time period for which the digital signage application has been executed, information regarding a time period taken to transmit the digital signage contents to another terminal, information regarding the amount of transmitted data, information regarding a time at which the digital signage contents have been output, etc.

If basic information for compensation is received, the digital signage manager 200 creates compensation information based on the received basic information for compensation (S519).

At this time, the digital signage manager 200 may create compensation information including coupon information, discount information for mobile phone payment, gift certificate information, point savings information, etc., in consideration of the information regarding the time period for which the digital signage application has been executed, the information regarding the time period taken to transmit the digital signage contents to the other terminal, the information regarding the amount of transmitted data, the information regarding the time at which the digital signage contents have been output, etc.

Then, the digital signage manager 200 transmits the compensation information created through operation S519 to the user terminal 100 (S521).

Therefore, according to the embodiment of the present invention, by transmitting compensation information to the user terminal 100, it is possible to raise the degrees of the user's interest and participation in digital signage contents.

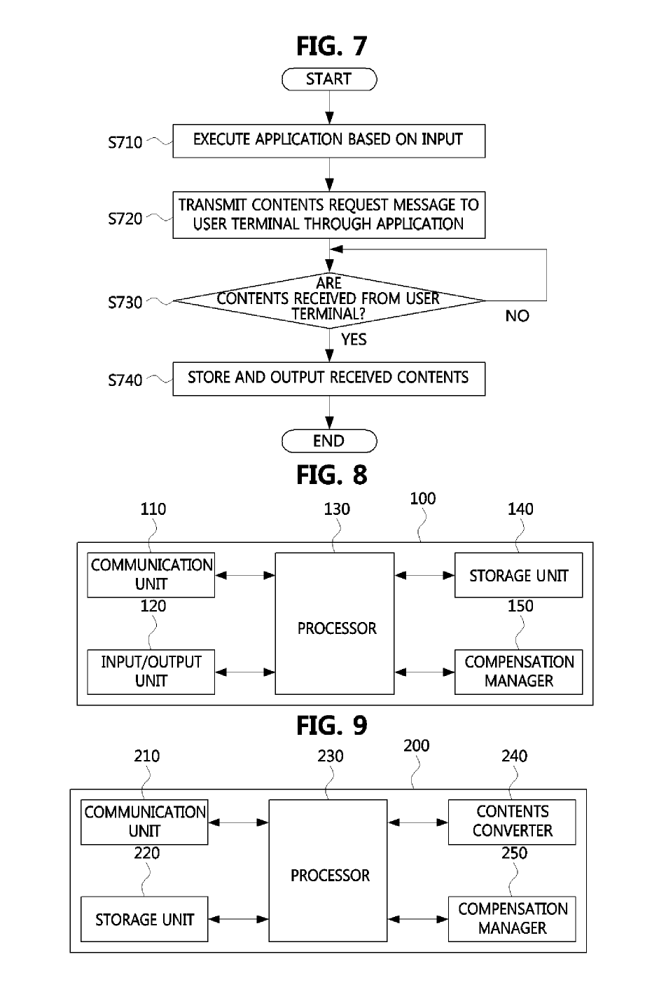

FIG. 7 is a flowchart illustrating a process of transmitting and receiving digital signage contents, which is performed by the other terminal 400, according to an embodiment of the present invention.

Hereinafter, it is assumed that the same digital signage application as that installed in the user terminal 100 has been installed in the other terminal 400.

Referring to FIGS. 1, 2, and 7, the other terminal 400 executes the digital signage application according to an input from a user (S710).

Then, the other terminal 400 transmits a digital signage contents request message to the user terminal 100 through the digital signage application executed through operation S710 (S720).

Thereafter, the other terminal 400 determines whether digital signage contents are received from the user terminal 100 (S730).

If digital signage contents are received from the user terminal 100, the other terminal 400 stores and outputs the received digital signage contents (S740).

If a contents transmission command with respect to the digital signage contents received and stored from the user terminal 100 is received from the digital signage manager 200, the other terminal 400 may acquire the digital signage contents and transmit them to another terminal.

Hereinafter, the user terminal 100 and the digital signage manager 200 that perform the method of transmitting and receiving digital signage contents according to the embodiment of the present invention will be described with reference to FIGS. 8 and 9.

The following components are defined not by physical classification but by functional classification. The individual components may be implemented as hardware and/or program codes and processing units for performing different functions, and the functions of two or more of the components may be combined to be performed by a single component.

Accordingly, in the following embodiments, names given to the components are aimed not at physically classifying the individual components but at describing representative functions that are performed by the respective components, and the scope of the present invention is not limited by the names of the components.

FIG. 8 is a block diagram illustrating a configuration of the user terminal 100 which performs the method of transmitting and receiving digital signage contents, according to an embodiment of the present invention.

Referring to FIG. 8, the user terminal 100 includes a communication unit 110, an input/output unit 120, a processor 130, a storage unit 140, and a compensation manager 150.

The communication unit 110 may receive digital signage contents from the digital signage manager (200 of FIG. 2) or another terminal (400 of FIG. 2), and perform communication with the digital signage manager 200 or the other terminal 400 under the control of the processor 130.

The communication unit 110 exchanges contents with the digital signage manager 200 or the other terminal 400 through a predetermined application. Communication between the communication unit 110 and the digital signage manager 200 or the other terminal 400 may be performed through at least one of Bluetooth, Zigbee, Wi-Fi, D2D, NFC, 3G, LTE, and WiBro.

Particularly, according to a data communication method, such as Wi-Fi, 3G, LTE, etc., by split-transmitting signage contents between applications installed in terminals through P2P communication such as BitTorrent, the terminals can exchange the signage contents at a high speed. Also, since contents are transmitted and received through applications installed in the terminals, privacy is ensured, and a user can easily subscribe to a service or unsubscribe from the service through management of applications.

The input/output unit 120 outputs the digital signage contents under the control of the processor 130, acquires information input by a user, and provides the acquired information to the processor 130.

The input/output unit 120 may be a liquid crystal display (LCD), a plasma display panel (PDP), an organic light emitting diode (OLED), etc.

The processor 130 executes the application according to an input from the user, and transmits a contents request message for requesting digital signage contents displayed on the digital signage display device (300 of FIG. 1) to the digital signage manager 200 through the communication unit 110 by the execution of the application.

Also, the processor 130 receives the digital signage contents corresponding to the contents request message from the digital signage manager 200 through the communication unit 110, and outputs the received digital signage contents through the input/output unit 120.

Alternatively, the processor 130 receives all or a part of the digital signage contents corresponding to the contents request message from other peripheral terminals through the communication unit 110, and outputs the received digital signage contents through the input/output unit 120.

The processor 130 causes the received digital signage contents to be managed/played through the input/output unit 120, instead of a large-scale screen.

Alternatively, the processor 130 receives the digital signage contents corresponding to the contents request message from the digital signage manager 200 through the communication unit 110, and stores the received digital signage contents in the storage unit 140.

Then, the processor 130 performs an interaction on the output digital signage contents according to a user input received through the input/output unit 120.

Meanwhile, if a contents transmission command for transmitting the digital signage contents is received from the digital signage manager 200 through the communication unit 110, the processor 130 acquires all or a part of the digital signage contents in response to the received contents transmission command and transmits the acquired digital signage contents to the other terminal 400.

In addition, the processor 130 transmits basic information for compensation received from the compensation manager 150 to the digital signage manager 200 through the communication unit 110.

Thereafter, the processor 130 receives compensation information corresponding to the basic information for compensation from the digital signage manager 200, and provides the compensation information to the compensation manager 150.

The storage unit 140 may be a large-scale non-volatile storage unit (for example, a hard disk drive), and store a digital signage application, digital signage contents, etc.

Here, the digital signage contents may be updated whenever they are used under the control of the processor 130.

The storage unit 140 may store various kinds of information set by a user, such as application programs required for execution of various contents, bookmarks, etc.

The compensation manager 150 creates basic information for compensation including information regarding a time period for which the application has been executed, information regarding a time period taken to transmit the contents to the other terminal 400, information regarding a time at which the contents have been output, etc., and provides the created basic information for compensation to the processor 130.

The compensation manager 150 may check and manage how often the user terminal 100 has downloaded and transmitted digital signage contents so as to establish a compensation system (for example, in consideration of download times, the amounts of downloaded data, transmission times, the amounts of transmitted data, etc.), and perform a time management function such as management of an accumulated time.

Also, the compensation manager 150 manages compensation information received from the processor 130.

The compensation information may include coupon information, discount information for mobile phone payment, gift certificate information, point savings information, etc.

FIG. 9 is a block diagram illustrating a configuration of the digital signage manager 200 which performs the method of transmitting and receiving digital signage contents, according to an embodiment of the present invention.

Referring to FIG. 9, the digital signage manager 200 may include a communication unit 210, a storage unit 220, a processor 230, a contents converter 240, and a compensation manager 250.

The communication unit 210 performs communication with a user terminal (100 of FIG. 1), and transmits digital signage contents, compensation information, etc. to the user terminal 100 under the control of the processor 230.

The communication unit 210 transmits/receives contents to/from the user terminal 100 through a predetermined application. Communication between the communication unit 210 and the user terminal 100 may be performed through at least one of Bluetooth, Zigbee, Wi-Fi, D2D, NFC, 3G, LTE, and WiBro.

Particularly, according to a data communication method, such as Wi-Fi, 3G, LTE, etc., by split-transmitting signage contents between applications installed in terminals through P2P communication such as BitTorrent, the communication unit 210 can exchange the signage contents with the user terminal 100 at a high speed. Also, since contents are transmitted and received through applications installed in terminals, privacy is ensured, and a user can easily subscribe to a service or unsubscribe from the service through management of applications.

The storage unit 220 may be a large-scale non-volatile storage unit (for example, a hard disk drive), and store a digital signage application, digital signage contents, etc.

Here, the digital signage application, the digital signage contents, etc. may be updated under the control of the processor 230.

Also, the storage unit 220 may store various kinds of information set by a manager, such as application programs required for execution of various contents, bookmarks, etc.

If the processor 230 first receives a digital signage contents request message for requesting digital signage contents displayed on a digital signage display device (300 of FIG. 1) from the user terminal 100 through the communication unit 210, the processor 230 acquires the digital signage contents displayed on the digital signage display device 300 from the storage unit 220.

Here, the digital signage contents request message may include information about a file format and resolution that are supported by the user terminal 100.

The processor 230 controls the contents converter 240 to convert the digital signage contents acquired from the storage unit 220 into a file format and/or resolution that is supported by the user terminal 100, and transmits the converted contents received from the contents converter 240 to the user terminal 100 through the communication unit 210.

If the digital signage contents request message for requesting the digital signage contents displayed on the digital signage display device 300 is not a first received contents request message, the processor 230 acquires information about peripheral terminals that store the corresponding digital signage contents through the communication unit 210.

The peripheral terminals that store the corresponding digital signage contents include terminals that store a part of the digital signage contents, as well as terminals that store all of the digital signage contents.

If the processor 230 acquires information about the peripheral terminals through the communication unit 210, the processor 230 decides the amounts of contents that are to be transmitted by the individual peripheral terminals, and transmits contents transmission commands to the respective terminals based on the decided amounts of contents.

Also, if the processor 230 receives basic information for compensation from the user terminal 100, the processor 230 controls the compensation manager 250 to create compensation information based on the received basic information for compensation.

The basic information for compensation may include information regarding a time period for which the digital signage application has been executed, information regarding a time period taken to transmit the digital signage contents to another terminal, information regarding the amount of transmitted data, information regarding a time at which the digital signage contents have been output, etc.

Then, the processor 230 may transmit the compensation information received from the compensation manager 250 to the user terminal 100 through the communication unit 210.

The contents converter 240 converts the received digital signage contents into a file format and/or resolution that is supported by the user terminal 100 under the control of the processor 230, and provides the converted digital signage contents to the processor 230.

At this time, the contents converter 240 may manage the converted digital signage contents.

The compensation manager 250 creates compensation information based on the basic information for compensation under the control of the processor 230, and provides the created compensation information to the processor 230.

At this time, the compensation manager 250 may create compensation information including coupon information, discount information for mobile phone payment, gift certificate information, point savings information, etc., in consideration of the information regarding the time period for which the digital signage application has been executed, the information regarding the time period taken to transmit the digital signage contents to the other terminal, the information regarding the amount of transmitted data, the information regarding the time at which the digital signage contents have been output, etc.

The digital signage manager 200 may further include a contents manager, a digital signage display device manager, an interaction unit, and a digital signage contents producer, which are not illustrated in FIG. 9.

The contents manager stores and manages produced digital signage contents.

The digital signage display device manager manages and monitors the states of digital signage display devices and digital signage display servers installed in different places.

The interaction unit provides a response to interaction information generated by each digital signage display device.

The digital signage contents producer produces and edits digital signage contents based on an input from a manager.

According to the embodiments of the present invention as described above, by providing compensation for execution of a digital signage application, downloading of contents, and transmission of contents, it is possible to raise the degrees of users' interest and participation in digital signage contents. In addition, by causing each of terminals storing contents to split-transmit the assigned contents, a transmission rate can increase.

While the example embodiments of the present invention and their advantages have been described in detail, it should be understood that various changes, substitutions, and alterations may be made herein without departing from the scope of the invention.

What is claimed is:

1. A method of transmitting and receiving digital signage contents, which is performed by a user terminal, comprising:
executing an application;
transmitting a message for requesting digital signage contents displayed on a digital signage display device to a digital signage manager through the application;
receiving the digital signage contents from at least another terminal; and
outputting the received digital signage contents.

2. The method of claim 1, wherein the receiving of the digital signage contents from the other terminal comprises receiving the individually splitted digital signage contents from the at least another terminal.

3. The method of claim 1, further comprising:
receiving a transmission command for transmitting all or a part of the output digital signage contents to another terminal from the digital signage manager;
acquiring digital signal contents corresponding to the received transmission command; and
transmitting the acquired digital signage contents to the other terminal.

4. The method of claim 3, further comprising:
creating basic information for compensation including at least one piece of information among information regarding a time period for which the application has been executed, information regarding a time period taken to transmit the digital signage contents to the other terminal, information regarding the amount of transmitted data, and information regarding a time at which the digital signage contents have been output; and
transmitting the created basic information for compensation to the digital signage manager.

5. The method of claim 3, wherein the user terminal performs communication with the other terminal through at least one of Bluetooth, Zigbee, Wi-Fi, Device to Device (D2D), Near Field Communication (NFC), 3^{rd} Generation (3G), Long Term Evolution (LTE), and Wireless Broadband (WiBro).

6. A method of transmitting and receiving digital signage contents, comprising:
receiving a message for requesting digital signage contents displayed on a digital signage display device from a terminal;
acquiring the digital signage contents corresponding to the message if the message is a first received message;
converting the acquired digital signage contents; and
transmitting the converted digital signage contents to the terminal.

7. The method of claim 6, wherein the converting of the acquired digital signage contents comprises converting the acquired digital signage contents such that the digital signage contents satisfy at least one of a file format and resolution that are supported by the terminal.

8. A method of transmitting and receiving digital signage contents, comprising:
receiving a message for requesting digital signage contents displayed on a digital signage display device from a terminal;
acquiring information about at least one terminal storing the digital signage contents if the message is not a first received message;
deciding an amount of the acquired contents that is to be transmitted by the at least one terminal; and
transmitting a contents transmission command to the at least one terminal based on the decided amount of contents.

9. The method of claim 8, further comprising:
receiving basic information for compensation from the least one terminal;
creating compensation information based on the received basic information for compensation; and
transmitting the created compensation information to the at least one terminal.

10. The method of claim 9, wherein the basic information for compensation includes at least one piece of information among information regarding a time period for which an application has been executed, information regarding a time period taken to transmit the digital signage contents to another terminal, information regarding the amount of transmitted data, and information regarding a time at which the digital signage contents have been output.

11. The method of claim 9, wherein the compensation information includes at least one piece of information among coupon information, discount information for mobile phone payment, gift certificate information, and point savings information.
